(19) United States
(12) Patent Application Publication
(10) Pub. No.: US 2015/0092858 A1
(43) Pub. Date: Apr. 2, 2015

(54) METHOD AND APPARATUS FOR PROCESSING IMAGE SIGNALS USING DIRECT MEMORY ACCESS (DMA)

(71) Applicant: SAMSUNG ELECTRONICS CO., LTD., Suwon-si (KR)

(72) Inventors: Won-chang LEE, Seongnam-si (KR); Do-hyung KIM, Hwaseong-si (KR); Si-hwa LEE, Seoul (KR)

(73) Assignee: SAMSUNG ELECTRONICS CO., LTD., Suwon-si (KR)

(21) Appl. No.: 14/502,315

(22) Filed: Sep. 30, 2014

(30) Foreign Application Priority Data
Sep. 30, 2013 (KR) 10-2013-0116898

(51) Int. Cl. H04N 19/423; H04N 19/80; H04N 19/51; G06F 13/28

(52) U.S. Cl. CPC H04N 19/00484; G06F 13/28; H04N 19/0089; H04N 19/00696
USPC 375/240.16; 375/240.29

(57) ABSTRACT

Disclosed is a method of processing image signals stored in a memory using a direct memory access (DMA) in a system including a digital signal processor (DSP). The method includes receiving, by the DMA which is located within a hardware block, data from a memory which is located outside the hardware block, transmitting the received data to a programmable filter, which is located inside the hardware block, through a transmission path inside the hardware block, and filtering, by the programmable filter which stores filter information, the received data using the filter information.

### RELATED APPLICATION

This application claims the benefit of Korean Patent Application No. 10-2013-0116898, filed on Sep. 30, 2013, in the Korean Intellectual Property Office, the disclosure of which is incorporated herein in its entirety by reference.

### BACKGROUND

1. Field

The present disclosure relates to methods and apparatuses for processing images using a programmable filter and a direct memory access (DMA).

2. Description of the Related Art

As hardware that may replay and store high-resolution or high-quality video content is developed and distributed, there is an increasing need for a video codec which effectively encodes or decodes high-resolution or high-quality video content. A filtering operation is essentially required in such an encoding or decoding job. Particularly in the decoding operation, a lot of data transmission is required in connection with the motion compensation.

In this regard, a direct memory access (DMA) transmission technology is affected by the encoding or decoding job.

However, when a filter and a memory are separated and are connected via a bus, a lot of time is needed in transmitting and receiving data and the system may be overloaded, and thereby efficient image processing may be difficult.

### SUMMARY

Provided are methods and apparatuses for using a direct memory access (DMA) controller in a method of processing image signals. An improved effect may be obtained in terms of speed and efficiency by linking a programmable filter when using the DMA controller.

Provided is a computer-readable medium having recorded a program for executing the above method in a computer.

Additional aspects will be set forth in part in the description which follows and, in part, will be apparent from the description, or may be learned by practice of the presented embodiments.

According to an aspect of the present invention, a method of processing image signals stored in a memory using a direct memory access (DMA) in a system including a digital signal processor (DSP) includes: receiving, by a DMA, which is located inside a hardware block, data from a memory which is located outside the hardware block; transmitting the received data to a programmable filter, which is located inside the hardware block, through a transmission path inside the hardware block; and filtering, by the programmable filter which stores filter information, the transmitted data using the filter information.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating an example of a general multi-core system for processing digital signals where a digital signal processor (DSP) is connected to a memory via a bus;

FIG. 2 is a block diagram illustrating an example where a direct memory access (DMA) and a programmable filter, which are formed as one hardware block, are connected to the general multi-core system via a bus, according to an embodiment of the present invention;

FIG. 3 is a flowchart illustrating an example of transmitting data, which the DMA receives from a memory, to a programmable filter, and filtering the received data, according to an embodiment of the present invention;

FIG. 4 is a flowchart illustrating an example where the programmable filter filters data received from the DMA by using a value of a stored filter coefficient set and the maximum filter degree, according to an embodiment of the present invention;

FIG. 5 is a flowchart illustrating an example of determining whether data received from the memory needs to be processed by the programmable filter, and transmitting the received data according to the determination, according to an embodiment of the present invention;

FIG. 6 is a flowchart illustrating an example of receiving data from the memory and transmitting the received data, and filtering the data and transmitting the filtered data to the DSP, according to an embodiment of the present invention;

FIG. 7 is a flowchart illustrating an example of determining whether a filter has been turned on and filtering block data, according to an embodiment of the present invention; and

FIG. 8 is a block diagram illustrating an apparatus for processing image signals by using the DMA, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

In the present specification, a digital signal processor (DSP) may be a microprocessor which is particularly prepared for digital signal processing, and may also refer to a kind of a central processing unit (CPU).

Furthermore, in the present specification, a direct memory access (DMA) may be a function of peripheral devices (a hard disk drive, a graphic card, a network card, a sound card, etc.) which have a direct access to a memory and read or write. Further, the DMA may also refer to a device which performs such a function. When the DMA is supported, the CPU does not need to participate in the data transmission, and thus the computer performance may be improved.

Furthermore, in the present specification, a register may be a small-scale data memory device contained inside a hardware block. Unlike an external hardware storage space connected via a bus, the register is located inside the hardware block, and thus the reading and writing speed is high.

Furthermore, in the present specification, motion compensation may be a kind of a compression method which estimates a next screen by comparing a previous screen with a current screen. Furthermore, in the present specification, the motion compensation may be a part of a process of forming data of the current frame using motion vector data, which is movement information of a subject within the past frame, and the past frame data.

Furthermore, in one or more embodiments of the present invention, “communication”, “communication network”, and “network” may be the same. The three expressions may be a wired or wireless local and global data transmission and reception network which may transmit and receive a file between a user terminal, terminals of other users, and a download server.

Furthermore, in the present specification, a computer-readable recording medium may be a medium which provides data so that a device performs a certain function.

Services implemented in an information age which is established based on a high-speed information communication network are being developed into multimedia type services which are seen and heard through a text, a voice, and an image. As such, the processor of a high-speed communication system processes massive data. In particular, when massive data such as multimedia and image data is transmitted, the system processor must often access the memory.

The performance of the system may be significantly changed by the data transmission speed between peripheral devices, which process data, and the memory device. A direct memory access (DMA) transmission technology is used to enhance the system performance. In the DMA transmission technology, the processor is not in charge of the data transmission. That is, direct data transmission is performed between the memory device and the peripheral devices which are connected via a bus. In order to perform such an operation, a DMA controller is used. In other words, in the DMA transmission technology, the DMA controller is in charge of the data transmission instead of the processor.

An embodiment of the present invention provides a method and apparatus for processing image signals using the DMA.

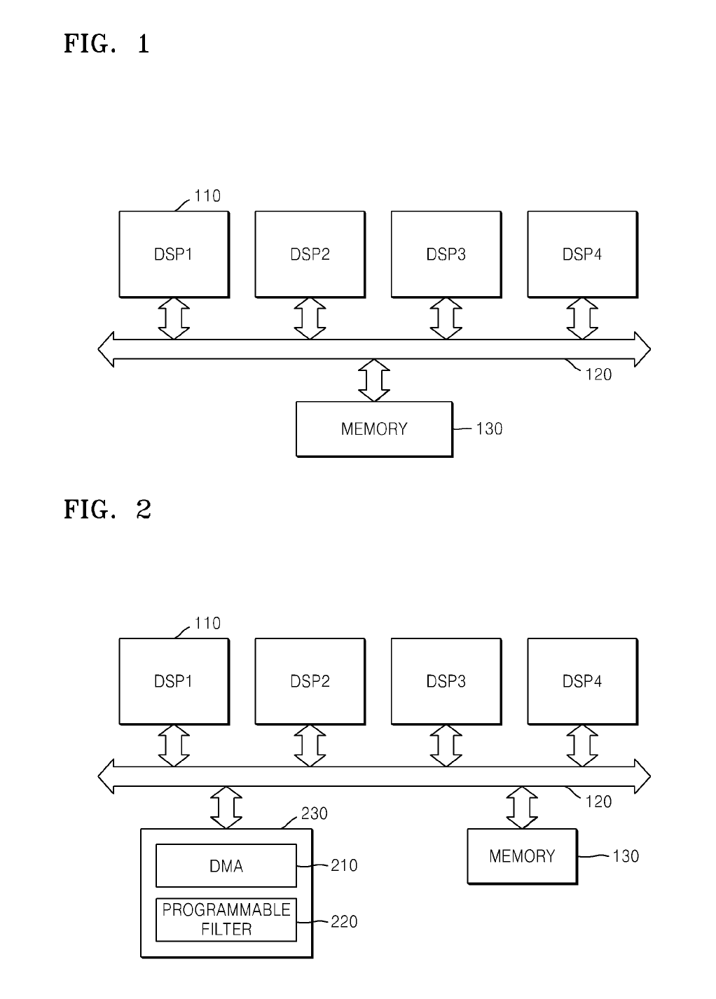

FIG. 1 is a block diagram illustrating an example of a general multi-core system for processing digital signals where one or more digital signal processors (DSP) 110 and a memory 130 are connected via a bus 120.

The one or more DSPs 110 and the memory 130 are connected to the bus 120, and the one or more DSPs may receive data from the memory 130 via the bus 120.

In order to support a next-generation codec or application such as a HEVC, a programmable DSP system, rather than hardware having a lot of restrictions, is essential. Hence, as shown in FIG. 1, one or more DSPs 110 are connected to the bus 120. Likewise, a multicore DSP system is substituted for the conventional hardware block. The hardware block has been designed to perform a dedicated function, and thus may process data faster than a general-purpose DSP. As such, if the DSP performs a function intended for the hardware block, the operation load becomes very large. Hence, an additional DSP may be needed. Otherwise, each core in the multicore DSP system may be overloaded, thereby deteriorating the performance of the multicore DSP system.

That is, the system of FIG. 1 is a general multicore DSP system. As shown in FIG. 1, a hardware block is not included for supporting the next-generation codec/application. In this case, each DSP 110 core has relatively a high operation load compared to the hardware block.

FIG. 2 is a block diagram illustrating an example where a direct memory access (DMA) 210 and a programmable filter 220, which are formed as one hardware block 230, are connected to the general multicore system via a bus 120, according to an embodiment of the present invention.

As described above, in order to support the next-generation codec or application such as the HEVC, a system which uses a general-purpose DSP 110 is more efficient than the hardware block 230 in which control conditions have already been determined. The hardware block 230 has been designed to perform dedicated functions, and thus data processing is quicker when compared to a general-purpose DSP 110. Hence, if the same function is performed by the DSP 110, the operation load gets relatively large.

If the system is formed of only a single DSP 110, there is an advantage that a general operation may be easily supported, but there is a disadvantage that the performance speed of the single DSP 110 may be lower than that of the hardware block 230.

That is, the overall system performance may be enhanced by using the DSP 110 to perform essential operations and adding only the minimum hardware logic to the system as in FIG. 1. Furthermore, the next-generation codec as well as the existing codec may be easily supported when the programmable filter 220 is added to the system of FIG. 1.

FIG. 2 shows the programmable filter 220 which is connected to the DMA 210 and is then connected to the entire system. The DMA 210 may be a device which is used to quickly receive data from an external memory in a multimedia system. Then the load of the multicore DSP 110 system may be reduced by adding the programmable filter 220 to the hardware block 230. In a system which decodes codec data such as MPEG4 and H.264, the block-type data, which is transmitted from an external memory 130 through the DMA 210, may be filtered in the post-processing operation. Hence, the filtering operation is the essential operation in the multimedia system, and the filter coefficient and filter degree of a programmable filter may be different depending on the type of the codec. In the case of the filter block which supports only the codecs such as HPEG4 and H.264 which are currently being implemented in general systems, the HEVC codec, which has a different filter coefficient and filter degree than the HPEG4 and H.264 codecs, may not be supported. In FIG. 2, all general filter operations may be supported by directly connecting the programmable filter to the DMA 210. If the filtered data is transmitted to the DSP 110, the filter operation load in the DSP 110 is lower than an unfiltered operation load, thereby lowering the overall load.

The image signal data may be stored in the memory 130. When the image signals need to be processed, the DSP 110 may request the DMA 210 to access the image signal data. If the DMA 210 receives a request from the DSP 110 to access the image signal data stored in the memory 130, the DMA 210 may be connected to the memory 130. Furthermore, the DMA 210 may read data which is needed for the image signal processing in the memory 130. Furthermore, the data, which has been read by the DMA 210, may be transmitted to the programmable filter 220. Furthermore, the programmable filter 220 may filter the data which is received from the DMA 210.

The DMA 210 and the programmable filter 220 are positioned inside one hardware block 230. Furthermore, one hardware block 230 including the DMA 210 and the programmable filter 220 may be connected to the memory 130 and the DSP 110 via the bus 120.

Hardware may include all physical parts of a computer. Furthermore, the hardware block 230 may be a block which is manufactured by configuring hardware in block units.

The hardware block 230 may be designed to perform a specific function. For example, the decoding speed of the hardware block 230, which decodes data encoded in an H.264 codec scheme, may be higher than the decoding speed of the DSP 110 when decoding the same data. However, the hardware block 230, which is specialized in decoding the data encoded in the H.264 codec scheme, may not able to decode the data encoded in another scheme.

Likewise, the hardware block 230 is optimized for performing a specific function, and thus the data processing speed of the hardware block may be faster than that of a general-purpose DSP 110. Hence, if the function, which may be performed in a dedicated manner inside the hardware block, is performed by the DSP 110, the operation load in the DSP 110 may become relatively high.

Generally, the hardware block 230 is designed to perform a special function, and thus a function other than the functions which were already set at the time of manufacturing the hardware block 230 may not be performed.

However, according to an embodiment of the present invention, one hardware block 230 including the DMA 210 and the programmable filter 220 may extend the range in which the function may be performed.

The range of the function may be extended by adjusting the filter coefficient of a filter coefficient controller included in the programmable filter 220.

Specifically, the filtering performed by the programmable filter 220 may be performed by an N-tab filter such as a 6-tab filter or an 8-tab filter.

For example, the 6-tab filter may be a filtering scheme which uses 6 coefficients to determine one pixel value. Specifically, the 6-tab filter may use 6 X values (i.e., variables) to calculate one pixel value P1, where a1·X1+a2·X2+a3·X3+a4·X4+a5·X5+a6·X6=P1. Here, coefficients a1 to a6 may be values determined depending on the type of the codec. A value, which is multiplied by a variable in the filtering, may be a coefficient. Furthermore one or more coefficients may form a filter coefficient set. Hence, in order to decode data which has been encoded by a new codec, a new filter coefficient set may be required.

By applying the embodiments of the present invention to video encoders/decoders which use codecs such H.264/AVC and HEVC, such as a TV, a computer, and a mobile phone, the bandwidth between the processor/hardware device and the memory 130 may be reduced and the operation of the processor/hardware may be partially reduced by using the programmable filter 220 included in the DMS 210, thereby improving the performance of the encoder/decoder of the codec.

In the case of the multimedia system which uses the DMA 210 and the programmable filter 220, the operation to be performed by the DSP 110 is partly performed in the DMA 210, and thus the load of the DSP 110 may be reduced and an unnecessary data overhead may be reduced, thereby improving the system performance. When the embodiments of the present invention are applied to a next generation codec or system which executes an application, a new filtering condition, which may be not provided by the conventional hardware block 230, may be easily supported by using features of the programmable filter 220. In the multicore system environment which uses the DSP 110 instead of one hardware block 230, the system performance may be further improved and the load of the DSP 110 may be further reduced.

The programmable filter 220 may perform encoding or decoding without a separate operation in the scheme of conventional codecs. Furthermore, the programmable filter 220 may perform encoding or decoding according to user settings in response to a new codec.

Some examples of the conventional codecs are H.264 and HEVC. Furthermore, an H.264 codec scheme may include filtering using a 6-tab filter scheme, and the HEVC codec may perform filtering using an 8-tab filter scheme.

The image signal, which is encoded by a predetermined codec, may be decoded in the decoding process. In the decoding operation, the image signals are motion compensated in the decoding. Motion compensation requires a large amount of data transmission in the decoding operation. Hence, motion compensation performed in the decoding operation by the DSP 110 may take a long time, thereby lowering the overall system speed. However, when the decoding operation related to the motion compensation is performed partly or entirely by the programmable filter 220, the overall system speed may be improved.

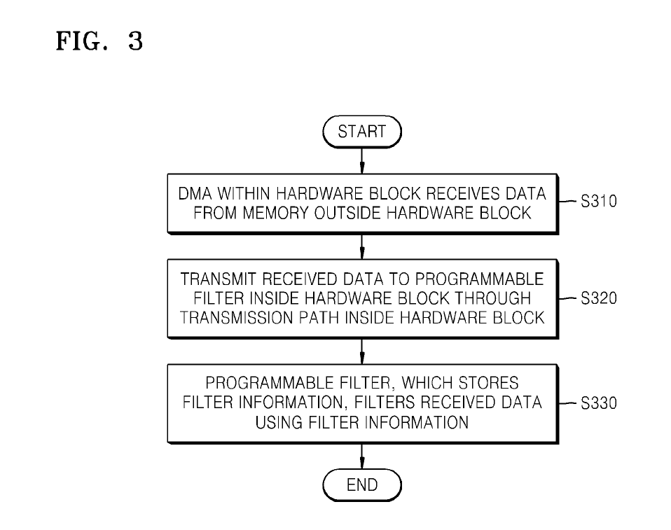

FIG. 3 is a flowchart illustrating an example of transmitting data which the DMA 210 receives from a memory to the programmable filter 220, and filtering the received data, according to an embodiment of the present invention.

In operation S310, the DMA 210, which is located inside the hardware block 230, may receive data from the memory 130, which is located outside the hardware block. The DMA 210 and the programmable filter 220 may be located together inside one hardware block 230. Furthermore, the memory 130 may be located outside the hardware block 230 in which the DMA 210 and the programmable filter 220 are located together. The hardware block 230, in which the DMA 210 and the programmable filter 220 are located together, may be connected to the memory 130 via the bus 120. The data, which the hardware block 230 receives from the memory 130, may be signals related to images.

In operation S320, the DMA 210 may transmit data received from the memory 130, to the programmable filter 220 located inside the hardware block 230, through a transmission path inside the hardware block 230. That is, the DMA 210 and the programmable filter 220 are located within the same hardware block 230, and thus data transmission is possible through the transmission path inside the hardware block 230. When data is transmitted using the transmission path inside the hardware block 230, the data may be transmitted and received faster than when connected via the bus 120. Hence, the overall speed of the transmitting and receiving of data may be improved.

In operation S330, the programmable filter 220, which stores filter information, may filter data transmitted in operation S320 using the filter information.

The filter information may include the maximum filter degree and the filter coefficient set.

The filter coefficient set may be determined as a set of values for decoding data encoded by a predetermined codec. Furthermore, the filter coefficient set may be pre-stored in a register inside the programmable filter 220.

Furthermore, the filtering may be performed by one of a 1-tab filter to a 20-tab filter.

Furthermore, the filtering performed by the programmable filter 220 may be an N-tab filter job such as a 6-tab filter or an 8-tab filter. Likewise, the number of values needed to determine one value is the maximum filter degree.

For example, the 8-tab filter may be a filtering scheme which determines one value using 8 values. Specifically, the 8-tab filter may use 8 X values to calculate one pixel value P1, where a1·X1+a2·X2+a3·X3+a4·X4+a5·X5+a6·X6+a7·X7+a8·X8=P1. Here, coefficients a1 to a8 may be values determined according to the codec type. The value, which is multiplied to a variable in the filtering, may be a coefficient. Furthermore, when one or more coefficients, which are needed for filtering, form one set, the set may be a filter coefficient set. Hence, a new filter coefficient set may be needed to decode data which is encoded by a new codec.

The coefficient of the value needed for obtaining one pixel value may be the maximum filter degree. The maximum filter degree of the above-mentioned 8-tab filter may be 8. At this time, although the maximum filter degree may be predetermined, the actual filter degree may be determined by the values of the filter coefficients. For example, if the maximum filter degree is 10 and there are 10 filter coefficients having respective values of 1, 2, 3, 4, 5, 6, 7, 8, 0, and 0, the filter coefficients having a value of 0 are excluded from the actual calculation, and only the 8 filter coefficients having a value which is not 0 are reflected in the calculation. In this case, the maximum filter degree is 10, but the actual filter degree is 8. However, in another example, the actual filter degree may also be 6. That is, although the maximum filter degree may be predetermined, the actual filter degree may be determined by the values of the filter coefficients.

Hence, even if the values of the filter coefficients are reset, the actual filter degree cannot exceed the maximum filter degree. The maximum filter degree may be predetermined when the apparatus is manufactured or may be set by the user after the apparatus is manufactured.

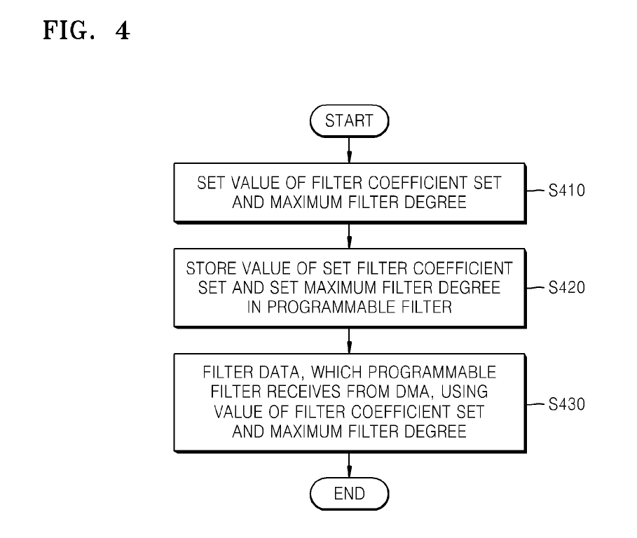

FIG. 4 is a flowchart illustrating an example where the programmable filter 220 filters data received from the DMA 210 by using values of the filter coefficients in the stored filter coefficient set and the maximum filter degree, according to an embodiment of the present invention.

In operation S410, the values of the filter coefficients in the stored filter coefficient set and the maximum filter degree may be set. The value of the filter coefficient set and the maximum filter degree may be set by the user. In detail, the user may determine the value of the filter coefficient set and the maximum filter degree using a method such as programming. In order to decode data which is encoded by a new codec scheme which has not existed before, the user may set the value of a new filter set and the maximum filter degree. Hence, decoding of the encoded data may be possible in a new codec which was not previously a part of the programmable filter 220.

In operation S420, the value of the filter coefficient set and the maximum filter degree, which are set in operation S410, may be stored in the programmable filter 220. The value of the filter coefficient set and the maximum filter degree, which are set in operation S410, may be stored in a register (not shown) which is located inside the programmable filter 220, which is located inside the hardware block 230. The register may be a small-scale data memory device. Furthermore, the register may be connected to other devices inside the hardware block 230 via an internal bus.

In operation S430, the programmable filter may filter data received from the DMA 210, using the value of the filter coefficient set and the maximum filter degree, which are stored in operation S420. The filtering operation may include a process of performing a part of the whole of the motion compensation. Furthermore, the motion compensation may be a part of the decoding process.

In detail, the motion compensation may be a type of a decoding method which estimates a screen that follows a current screen by comparing a previous screen with the current screen. Furthermore, the motion compensation may be a process of using a motion vector, which is movement information of a subject in the past frame, and a part or the entirety of processed data of the past frame to predict data of the current frame

As described above, the filtering may be a process of obtaining one pixel value using a plurality of pixel values. Furthermore, the filtering may be a part or the whole of the decoding process. In detail, the filtering performed by the programmable filter 220 may be an N-tab filter job such as a 6-tab filter or an 8-tab filter.

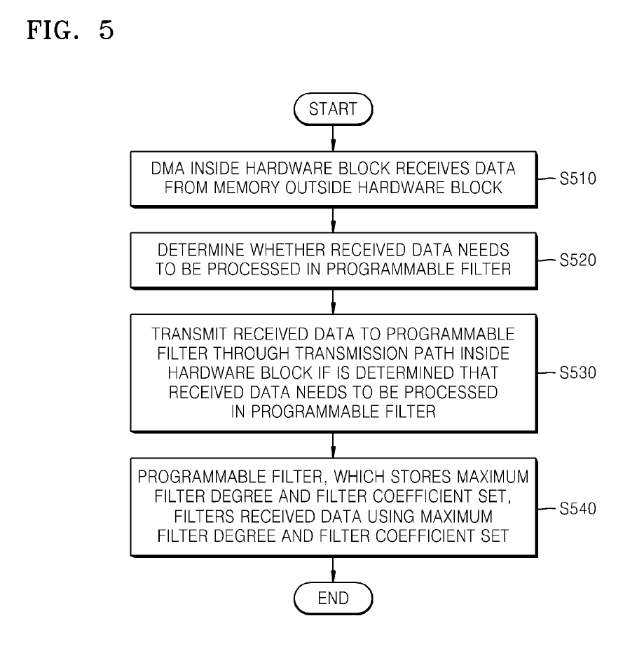

FIG. 5 is a flowchart illustrating an example of determining whether data received from the memory 130 needs to be processed by the programmable filter 220, and transmitting the received data according to the determination, according to an embodiment of the present invention.

Referring to FIG. 5, a method of processing image signals using the DMA 210 according to an embodiment of the present invention includes operations performed sequentially in the method of processing image signals using the DMA illustrated in FIG. 3. Hence, the above description with respect to the method of processing image signals using the DMA 210 illustrated in FIG. 3 may also be applied to the method of processing image signals using the DMA 210 according to the present embodiment even if omitted below. FIG. 5 is different from FIG. 3 with regard to operations S520 and S530, and thus the description below will center on the differences therebetween.

Operation S510 corresponds to operation S310.

In operation S520, the DMA 210 may determine whether data received in operation S510 needs to be processed by the programmable filter 220. In detail, in the case in which the DMA 210 determines that the data received in operation 510 (i.e., the data received from the memory 130 does not require filtering (i.e., does not need to be processed by the programmable filter 220), the DMA 210 may directly transmit the data received from the memory 130 to the DSP 110 without filtering the data using a filtering operation.

However, when the DMA 210 determines that the data received in operation S510 needs to be processed by the programmable filter 220, the DMA 210 may transmit the data received from the memory 130 to the programmable filter 220 through the transmission path inside the hardware block 230.

In operation S530, as a result of the determination in operation S520, if the DMA 210 determines that the data received in the memory 130 needs to be processed by the programmable filter 220, the DMA 210 may transmit data received from the memory 130 to the programmable filter 220 through the transmission path inside the hardware block 230.

Operation S540 corresponds to operation S330.

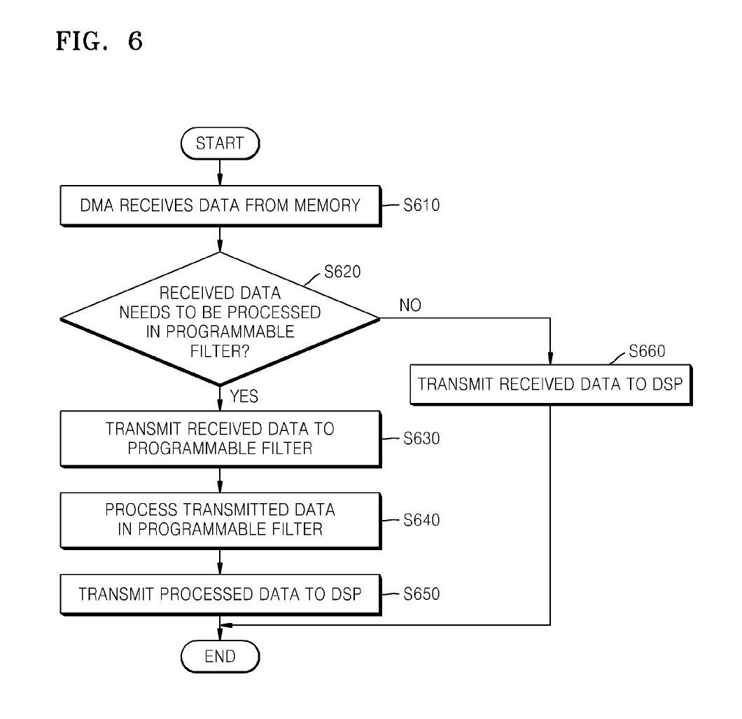

FIG. 6 is a flowchart illustrating an example of receiving data from the memory 130, transmitting the received data, filtering the transmitted data, and transmitting the filtered data to the DSP 110, according to an embodiment of the present invention.

In operation S610, the DMA 210 may receive data from the memory 130. When receiving data from the memory 130, the DMA 210 may receive the data via the bus 120. The memory 130 may be located outside the hardware block 230 in which the DMA 210 is located.

In operation S620, the DMA 210 may determine whether data received in operation S610 needs to be processed by the programmable filter 220. In detail, components in charge of determination may be located inside the DMA 210.

When it is determined in operation S620 that the data received from the memory 130 needs to be processed by the programmable filter 220, the process proceeds to operation S630.

In operation S630, the data received in operation S620 may be transmitted to the programmable filter 220. When the data received in operation S620 is transmitted to the programmable filter 220, the data may be transmitted through the transmission path inside the hardware block 230 where the DMA 210 and the programmable filter 220 are located together.

In operation S640, the data transmitted in operation S630 may be processed by the programmable filter 220. Filtering may be specifically performed by the programmable filter 220.

In operation S650, the data processed in operation S640 may be transmitted to the DSP 110.

In operation S660, the data, which the DMA 210 receives from the memory 130 in operation S610, is transmitted to the DSP 110.

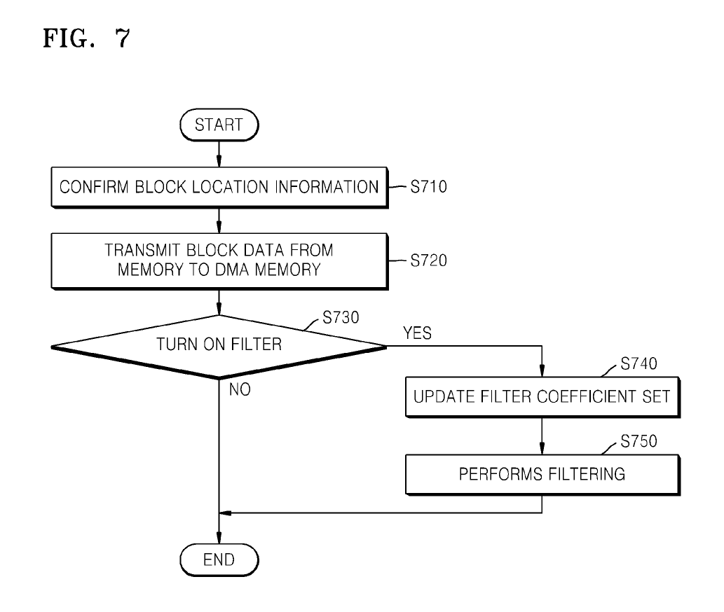

FIG. 7 is a flowchart illustrating an example of determining whether block data needs to be filtered and filtering the block data, according to an embodiment of the present invention.

In operation S710, location information of the block data may be checked.

In operation S720, the block data may be transmitted from the memory 130 to the DMA 210.

In operation S730, it may be determined whether the data transmitted in operation S720 needs to be filtered.

When it is determined in operation S730 that the data transmitted in operation S720 needs to be filtered, the filter coefficient set may be updated in operation S740.

When it is determined in operation S730 that the data transmitted in operation S720 does not need to be filtered, the block data transmitted in operation S720 may be transmitted to the DSP 110 without being filtered.

In operation S750, the filtering may be performed using the filter coefficient set which is updated in operation S740. The filtering may be vertically or horizontally performed(?). After filtering is performed, the filtering result may be transmitted to the DSP 110.

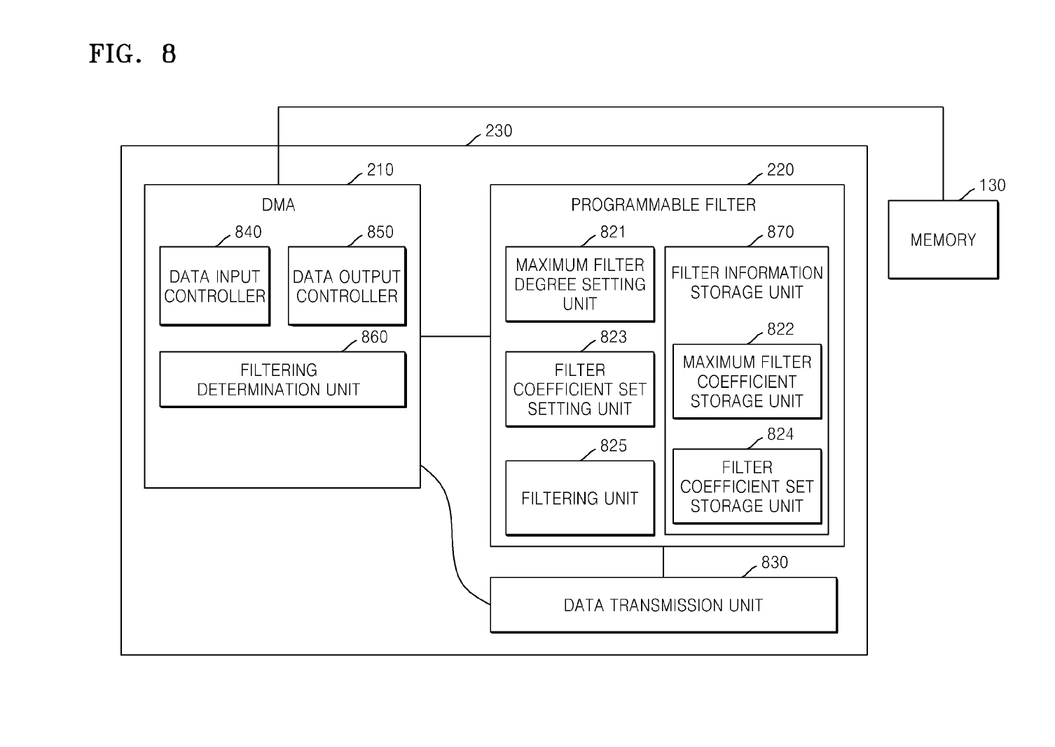

FIG. 8 is a block diagram illustrating an apparatus for processing image signals by using the DMA 210, according to an embodiment of the present invention.

The data stored in the memory 130 may be transmitted to the DMA 210. Furthermore, the data, which is transmitted to the DMA 210, may be transmitted to the programmable filter 220 depending on a determination result made by a filtering determination unit 860. Furthermore, the data, which is transmitted to the programmable filter 220, may be filtered by a filtering unit 825. The filtering may be performed using the maximum filter degree and the filter coefficient set. The actual filter degree may be determined by setting the filter degree to the maximum N and setting the value of the filter coefficient set. For example, if the maximum filter degree is set to 8 and the values of the filter coefficient set are determined as 1, 2, 3, 4, 0, 0, 0, and 0, the actual filter degree is 4. Furthermore, the filtering unit 825 may be a 4^{th} degree filter. Methods of determining the value of the filter coefficient set may include a method of externally setting the value of the filter coefficient set and the method of determining the value of the filter coefficient set for each filter operation. The filter coefficient set may have coefficients having different respective values depending on the type or performance of the codec.

The DMA 210 may be located inside the hardware block 230, and may receive data from the memory 130, which is located outside the hardware block 230.

Furthermore, the programmable filter 220 may be located inside the hardware block 230 in which the DMA 210 is located. Furthermore, the programmable filter 220 may receive data which has been received by the DMA 210 through the transmission path inside the hardware block 230.

Likewise, the programmable filter 220 and the DMA 210 may be located inside the same hardware block 230. Hence, the data transmission between the programmable filter 220 and the DMA 210 may be performed through the transmission path inside the hardware block 230. Hence, the data transmission between the programmable filter 220 and the DMA 210 may also be performed through an internal bus. Hence, the data transmission between the programmable filter 220 and the DMA 210 may be faster than data transmission via a general bus 120.

The DMA 210 and the programmable filter 220 may be located inside one hardware block 230. Furthermore, one hardware block 230 including the DMA 210 and the programmable filter 220 may be connected to the memory 130 via the bus 120. The memory 130 may be located outside the hardware block 230 in which the DMA 210 and the programmable filter 220 are located together.

Furthermore, the DMA 210, which is located inside the hardware block 230, may receive data from the memory 130, which is located outside the hardware block 230.

Furthermore, the data, which the hardware block 230, in which the DMA 210 and the programmable filter 220 are located together, receives from the memory 130, may be a signal related to the image.

The data input controller 840, the data output controller 850, and the filtering determination unit 860 may be located inside the DMA 210.

The data input controller 840 may receive data from the memory 130. Specifically, if the command to read data is transmitted from the DSP 110 to the DMA 210, the data input controller 840, which is located inside the DMA 210, may receive data, which is related to image signals, from the memory 130.

The data received through the data input controller 840, may be transmitted to the filtering determination unit 860. Furthermore, the filtering determination unit 860 may determine whether the data received through the data input controller 840, is data which must be filtered. Furthermore, the filtering determination unit 860 may determine whether the data received through the data input controller 840, is data which must be filtered by the programmable filter 220. For example, when data which has already been filtered is received through the data input controller 840, it may be determined that the filtering is unnecessary. However, when data which has not been filtered is received through the data input controller 840, it may be determined that the filtering is necessary.

The data output controller 850 may transmit the data received from the memory through the data input controller 840, to the programmable filter 220 or the data transmission unit 830. In detail, when the filtering determination unit determines that the filtering is necessary, the data output controller 850 may transmit the data, which has been received through the data input controller 840, to the programmable filter 220. However, when the filtering determination unit 860 determines that the filtering is not necessary, the data output controller 850 may transmit the data, which has been received through the data input controller 840, to the data transmission unit 830.

The data transmission unit 830 may transmit the data which has been received from the DMA 210 or the programmable filter 220, to the DSP 110.

The programmable filter 220 may store the maximum filter degree and one or more filter coefficient sets. In detail, the maximum filter degree may be stored in a maximum filter degree storage unit 822, and the filter coefficient set may be stored in a filter coefficient set storage unit 824.

A filter coefficient set setting unit 823 may be located inside the programmable filter 220. Furthermore, the filter coefficient set setting unit 823 may set the value of the filter coefficient set. The filter coefficient set setting unit 823 may determine the value of a new filter coefficient set by receiving a user's input. Furthermore, the filter coefficient set setting unit 823 may set the values of the coefficients in the filter coefficient set in a register to be equal to values of coefficients of a pre-stored filter coefficient set.

The filter coefficient set storage unit 824 may be located inside the programmable filter 220. Furthermore, the filter coefficients set storage unit 824 may store one or more filter coefficient sets. Furthermore, the filter coefficient set storage unit 824 may store the value of the filter coefficient set which is determined by the filter coefficients set setting unit 823. The values of the coefficients in the stored filter coefficient set may be) for decoding data which has been encoded by a predetermined codec. The filter coefficient set may be pre-stored in a register which is located inside the programmable filter 220.

A maximum filter degree setting unit 821 may be located inside the programmable filter 220. Furthermore, the maximum filter degree setting unit 821 may set the value of the maximum filter degree. The maximum filter degree setting unit 821 may determine the value of a new maximum filter degree by receiving a user's input. Furthermore, the maximum filter degree setting unit 821 may determine the value of the maximum filter degree in a manner that records the already stored maximum filter degree value in the register.

The maximum filter degree storage unit 824 may be located inside the programmable filter 220. Furthermore, the maximum filter degree storage unit 824 may store the value of the maximum filter degree. Furthermore, the maximum filter degree storage unit 824 may store the value of the maximum filter degree which is determined by the maximum filter degree setting unit 821. The stored maximum filter degree may be determined as a value for decoding data which has been encoded by a predetermined codec. The value of the maximum filter degree may be pre-stored in the register which is located inside the programmable filter 220.

The maximum filter degree storage unit 822 and the filter coefficient set storage unit 824 may be located inside the filter information storage unit 870.

The filtering unit 825 may be located inside the programmable filter 220. Furthermore, the filtering unit 825 may use the maximum filter degree and the value of the filter coefficient set to filter data which is transmitted from the DMA 210.

Furthermore, the filtering unit 825 may perform a part or the whole of the motion compensation. Furthermore, the filtering unit 825 may partially or fully perform filtering by using one of a 1-tab filter to a 10-tab filter.

Furthermore, the filtering may be a process of obtaining one pixel value using a plurality of pixel values as described above. Furthermore, filtering may be a part or the whole of the decoding process. In detail, the filtering, which is performed by the programmable filter 220, may be an N-tab filter such as a 6-tab filter or a 8-tab filter.

The method and apparatus for processing image signals using the DMA 210 according to an embodiment of the present invention may be recorded in a computer-readable recording medium and the above-described functions may be performed by execution by a computer.

Furthermore, such codes may further include additional information, which is needed for the computer processor to perform the above-described functions, or codes which are related to the memory reference on at which locations (addresses) of an internal or external memory of the computer, media need to be referenced.

The computer-readable recording medium having recorded the above-described program may include an ROM, a RAM, a CD-ROM, a magnetic tape, a floppy disk drive, and an optical media storage device.

A computer, which may read a recording medium having recorded an application which is a program for executing a method and apparatus for processing image signals using the DMA 210 according to each embodiment of the present invention, may include a general personal computer (PC) such as a desktop computer and a notebook computer, a mobile terminal such as a smart phone, a tablet PC, a personal digital assistant (PDA), and a mobile communication terminal, and any other computing-possible device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of processing image signals stored in a memory using a direct memory access (DMA) in a system including a digital signal processor (DSP), the method comprising:
receiving, by a DMA, which is located inside a hardware block, data from a memory which is located outside the hardware block;
transmitting the received data to a programmable filter, which is located inside the hardware block, through a transmission path inside the hardware block; and
filtering, by the programmable filter which stores filter information, the transmitted data using the filter information.

2. The method of claim 1, wherein the filter information includes a maximum filter degree and a filter coefficient set.

3. The method of claim 2, further comprising:
setting a value of the filter coefficient set; and
storing a set value of the filter coefficient set in the programmable filter.

4. The method of claim 1, further comprising:
transmitting the filtered data to the DSP.

5. The method of claim 2, wherein the filter coefficient set comprises values for decoding data which is encoded by a predetermined codec.

6. The method of claim 5, wherein the codec includes an H.264 codec and an HEVC codec.

7. The method of claim 2, wherein the filter coefficient set is pre-stored in a register which is located inside the programmable filter.

8. The method of claim 2, further comprising:
setting the maximum filter degree; and
storing the set maximum filter degree in the programmable filter.

9. The method of claim 2, where the maximum filter degree is predetermined and an actual filter degree is determined according to values of filter coefficients in the filter coefficient set.

10. The method of claim 1, wherein the filtering comprises partially or fully performing motion compensation.

11. The method of claim 1, further comprising:
determining whether the received data needs to be processed by the programmable filter,
wherein the transmitting comprises transmitting the received data to the programmable filter if it is determined that the received data needs to be processed by the programmable filter.

12. An apparatus for processing image signals stored in a memory using a direct memory access (DMA) in a system including a digital signal processor (DSP), the apparatus comprising:
the DMA, which is located inside a hardware block and receives data from a memory which is located outside the hardware block;
a programmable filter which is located inside the hardware block and receives the received data transmitted through a transmission path inside the hardware block;
a filter information storage unit which is located inside the programmable filter and stores filter information; and
a filtering unit which is located inside the programmable filter and filters the received data using the filter information.

13. The apparatus of claim 12, wherein the filter information includes a maximum filter degree and a filter coefficient set.

14. The apparatus of claim 13, further comprising:
a filter coefficient set setting unit which sets a value of the filter coefficient set; and
a filter coefficient set storage unit which stores a set value of the filter coefficient set.

15. The apparatus of claim 12, further comprising:
a data transmission unit which transmits the filtered data to the DSP.

16. The apparatus of claim 13, wherein the filter coefficient set comprises values for decoding data which is encoded by a predetermined codec.

17. The apparatus of claim 13, wherein the filter coefficient set is pre-stored in a register which is located inside the programmable filter.

18. The apparatus of claim 13, further comprising:
a maximum filter degree setting unit which sets the maximum filter degree; and
a maximum filter degree storage unit which stores the set maximum filter degree.

19. The apparatus of claim 12, further comprising:
a filtering determination unit which determines whether the received data needs to be processed by the programmable filter,
wherein the DMA transmits the received data to the programmable filter if it is determined that the received data needs to be processed by the programmable filter.

20. A non-transitory computer-readable recording medium having recorded a program, which, when executed by a computer, performs the method of claim 1.
